(19) United States
(12) Patent Application Publication
(10) Pub. No.: US 2003/0178372 A1
(43) Pub. Date: Sep. 25, 2003

(54) Separation processes and apparatus

(76) Inventors: Charlotte R. Droughton, Stafford, TX (US); Wenping Li, Stafford, TX (US)

Correspondence Address: SPENCER C. PATTERSON, Fish & Richardson P.C., 60 South Sixth Street, 3300 Dain Rauscher Plaza, Minneapolis, MN, 55402, US

(21) Appl. No.: 10/323,437

(22) Filed: Dec. 18, 2002

Related U.S. Application Data
(60) Provisional application No. 60/342,208, filed on Dec. 19, 2001.

(51) Int. Cl. C02F 1/00

(52) U.S. Cl. 210/739; 210/743; 210/770; 210/804; 705/1

(57) ABSTRACT

Processes and apparatus are presented which allow efficient use of solid/liquid and liquid/liquid stages with chemical additives in separations technology.

### CROSS-REFERENCE TO RELATED APPLICATIONS

This application is related to co-pending provisional application serial No. 60/342,208, filed Dec. 19, 2001, which is incorporated by reference herein.

### BACKGROUND OF THE INVENTION

1. Brief Description of the Invention

The present invention generally concerns treatment of waste streams. More particularly, the present invention pertains to solid/liquid and liquid/liquid separation methods and apparatus used to treat waste streams, particularly catalyst waste streams, using inventive combinations of unit operations and chemicals.

2. Related Art

The unit operations of flocculation, filtration, dewatering, thickening, and clarification, and the equipment generally used to perform these functions, have known meanings to those skilled in the solid/liquid and liquid/liquid separations branches of chemical engineering. The use of chemical additives such as acids, bases, filtering aids, such as surfactants, clays, zeolites, anionic polymers, cationic polymers, nonionic polymers, and the like, are also known in their individual capacity. However, the ability to analyze and optimize a particular system employing these unit operations in conjunction with these chemicals remain challenging even today, especially when the stream to be treated contains very small particles. Many in the chemical engineering art would appreciate there is a need for improvement in processes and apparatus for removal of most or all particles from such fluid streams.

### SUMMARY OF THE INVENTION

In accordance with the present invention, processes and apparatus that use one or more of these unit operations in conjunction with two or more of treatment chemicals are presented which improve on the previously known processes and apparatus.

A first aspect of the invention is a solid/liquid separation process for treating a fluid stream comprising solid particles, wherein about 80 percent of the solid particles have particles size of 25 micrometers or less (preferably 100 percent have particle size of 25 micrometers or less, more preferably 90 percent have size of 4 micrometers of less), the process employing a pretreatment stage, a thickening stage, a dewatering stage, and a clarification stage, the process comprising of steps of:

(a) performing a first separate running of each of pretreatment stage, thickening stage, dewatering stage, and a clarification and recovery stage, including:

i. determining primary pretreatment chemical dosages of a pH additive, a modified zeolite, an anionic polymer, and a cationic polymer, and by jar test and setting up of a pretreatment optimization database including parameters selected from the group consisting of zeta potential, particle size distribution, solids weight percent, pH, turbidity, composition, and combination thereof, of the fluid stream, and a pretreatment optimization system (such as a streaming potential technique);

ii. with the best pretreatment identified, performing a thickening stage test by changing feed rate to and underflow rate from a thickening stage to determine best underflow rate and overflow rate corresponding to different feeding rates by evaluating the clarity of the overflow, and the solid content of the underflow;

iii. under steady operation of the thickening stage, performing a dewatering stage test to determine best operating conditions such as the maximum operating pressure for a filter, and decanter feeding rate, pool depth, rotating rate, solids retention time under different dewatering stage feed concentrations by evaluating cycle filtrate or centrate rate, clarity of filtrate, cake solid content, cake peeling out characteristics for the filter, and the like;

iv. determining cycle rate, filtrate clarity, and solids product purity under different operating conditions for the clarification and recovery stage;

(b) series running of steps (a)(i)-(iv) simultaneously based on operating data obtained from the first separate running of each stage separately, setting up best operating conditions for each stage under conditions provided by the preceding stage;

(c) modifying the overall process based on testing results from step (b) and unpredicted factors during operations; and, preferably if needed

(d) process design and scale up, cost analysis based upon the capacity requirement and information from steps (a), (b), and (c).

A second aspect of the invention is an apparatus for solid/liquid separations, the apparatus comprising:

(a) a pretreatment means adapted to absorb, coagulate and flocculate solid particles within a fluid stream;

(b) the pretreatment means fluidly connected to a means for thickening;

(c) the means for thickening fluidly connected to means for dewatering selected from the group consisting of a plate and frame filter, a decanter centrifuge, and combinations thereof; and

(d) the means for thickening also fluidly connected to a means for purification and recovery comprising at least one of a guard filter, a coalescer, and a carbon bed.

Further aspects of the inventive processes and apparatus will become apparent from the brief description of the drawings and preferred embodiments that follow, which in no way limit the appended claims.

### BRIEF DESCRIPTION OF THE DRAWINGS

FIGS. 1-1 and 1-2 are schematic process flow diagrams of one embodiment of the processes and apparatus of the invention;

FIG. 2-1 is a graph of accumulated particle size distribution of a sample from a commercial mill;

FIG. 3-1 is a schematic process flow diagram of a thickener stage;

FIG. 3-2 is a schematic logic diagram of instruction on how underflow and overflow rates are adjusted in accordance with one embodiment of the invention;

FIG. 3-3 is a schematic logic flow diagram of a thickener stage testing procedure;

FIG. 4-1 is a cross-sectional, side elevation view of a typical plate and frame filter useful in the invention;

FIG. 4-2 is a graph of filter operation under pumping pressure;

FIG. 5-1 is a cross-sectional, side elevation view of a typical decanter centrifuge useful in the invention;

FIG. 5-2 is a schematic logic flow diagram of a decanter centrifuge stage testing procedure;

FIG. 6-1 is a schematic of a funnel gravity filtration unit useful in the invention; and

FIG. 6-2 is a graph of accumulated particle size distribution of ground zeolite useful in practicing the invention.

### DESCRIPTION OF PREFERRED EMBODIMENTS

Overview

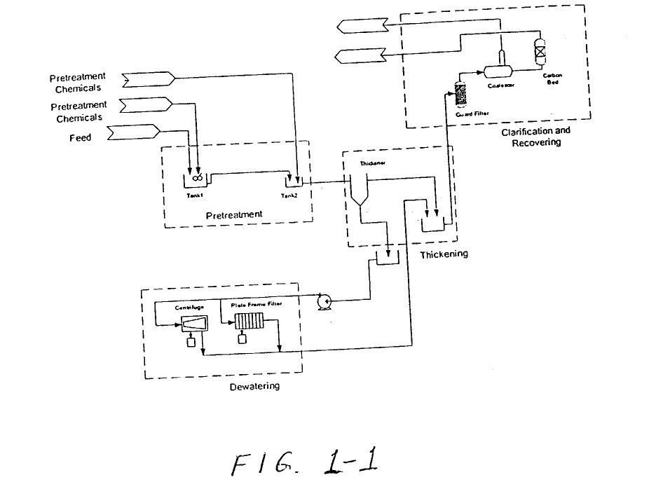

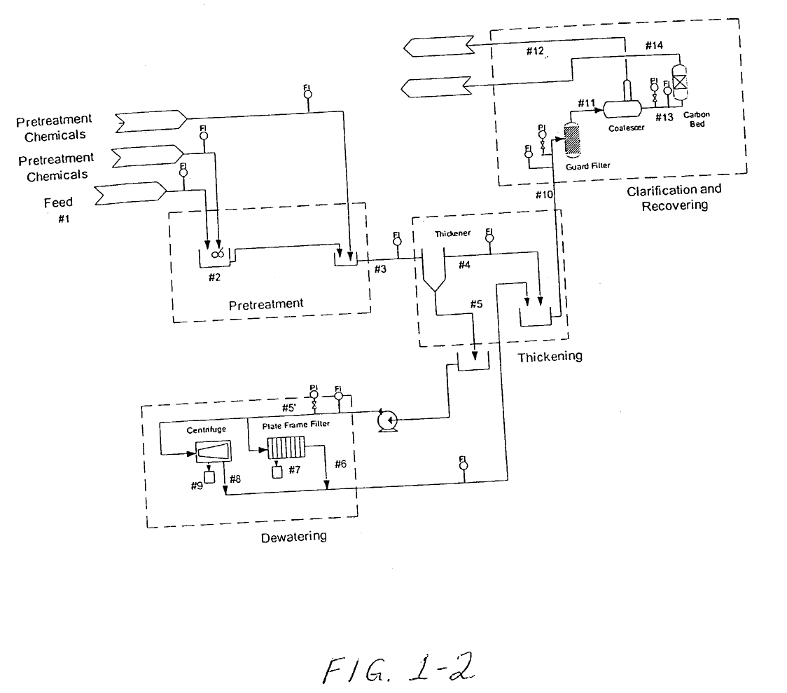

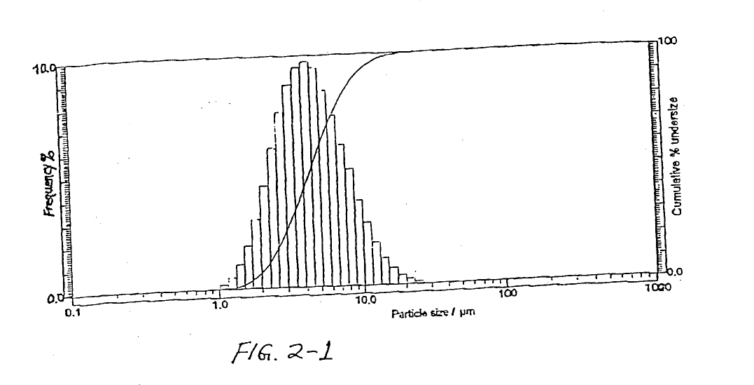

Separation processes and apparatus of the invention comprise an absorption, coagulation and flocculation pretreatment stage, a thickener stage, a solid/liquid separation stage, and a liquid/liquid separation stage. These processes and apparatus have been designed for removal of metal ions (particularly one or more of aluminum ions, iron ions, selenium ions, heavy metal ions and non-charged species of cadmium, palladium, platinum, rhodium, and the like) and fine solid particles, as well as hydrocarbon recovery from fluid streams containing same. The process is illustrated schematically in FIGs. 1-1 and 1-2.

There are preferably four stages in each embodiment of the inventive processes (in some cases thickening may not be necessary, for example):

1. Pretreatment: absorption, coagulation and flocculation;

2. Thickening;

3. Dewatering: plate and frame filter or decanter centrifuge;

4. Purification and recovery: guard filter, coalescer, and carbon bed.

An objective of the invention is to test and gathering data and information that will not be predicated by lab test for design, operation, and optimization of the four stages. For example:

1. Pretreatment optimization;

2. Gathering thickening data for thickener scale up;

3. Obtaining filtration or centrifugation data for dewatering equipment selection and scale up;

4. Guard Filter, coalescer, carbon bed optimization and scale up.

5. Un-predicated information for the whole process design and operation.

Sampling and Testing Points

In the embodiment illustrated in FIG. 1-1, testing results from each part of the process including pretreatment, thickening, dewatering, clarification and recovery are analyzed and evaluated first separately, and then simultaneously coordinated for equipment design and scale up and overall process design and optimization.

Preferred sampling points for testing such as solid concentration, particle size distribution (PSD), turbidity, and compositions, and the points for pressure or flow rate monitoring are indicated in FIG. 1-2. A summary of testing points is listed in Table 1-1. Additional testing data will be indicated in the detailed testing procedures.

TABLE 1-1
Sampling Points and Pressure or Flow Rate Monitoring Points

| | | Measuring | | Sampling analysis | | | | | |
|---|---|---|---|---|---|---|---|---|---|
| Point | | Flow rate(or | | Solid % | | Turbi- | Zeta | Compo- | |
| # | Description | total volume) | pressure | (weight) | PDS | dity | potential | sition | S.G. |
| 1 | Feeding slurry | ✓ | | ✓ | ✓ | ✓ | ✓ | ✓ | |
| 2 | Pretreatment tank 1 | C | | | | | ✓ | | |
| 3 | Feeding of thickener | ✓ | | ✓ | ✓ | | ✓ | ✓ | |
| 4 | Overflow of the thickener | ✓ | | ✓ | ✓ | ✓ | | ✓ | |
| 5 | Underflow of the | C | | ✓ | ✓ | | | ✓ | ✓ |
| | thickener | | | | | | | | |
| 5′ | Feeding of the filter | ✓ | ✓ | | | | | | |
| 5″ | Feeding of the decanter | ✓ | | | | | | | |
| 6 | Filtrate of the filter | ✓ | | ✓ | ✓ | ✓ | | ✓ | |
| 7 | Cake of the filter | C | | ✓ | | | | C | |
| 8 | Centrate of the decanter | ✓ | | ✓ | ✓ | ✓ | | ✓ | |
| 9 | Cake of the decanter | C | | ✓ | | | | C | |
| 10 | Feeding of the guard filter | ✓ | ✓ | ✓ | ✓ | ✓ | | C | |
| 11 | Filtrate of the guard filter | ✓ | | ✓ | ✓ | ✓ | | ✓ | |
| 12 | Toluene from the | | | | | | | ✓ | |
| | coalescer | | | | | | | | |
| 13 | Feeding of the carbon bed | ✓ | ✓ | | | | | ✓ | |
| 14 | Filtrate of the carbon bed | ✓ | | ✓ | ✓ | ✓ | | ✓ | |

Note: 5, 5′ and 5″ are actually the same sample.
“✓”- to be measured or analyzed;
“C”- to be calculated.
“S.G”- Specific gravity.

Testing Procedure

In the embodiments illustrated in FIGS. 1-1 and 1-2, the four stages: pretreatment, thickening, dewatering, clarification and recovery are in series. Any operating changes of the former unit will affect operation and results of the following unit. (As used herein the term “unit” is used when referring to an apparatus, while “stage” is used when referring to a process of the invention. This is simply a convention, and is not intended in any way to limit the invention. The terms could easily be reversed.) It is suggested to run each unit separately to obtain the primary optimizing operating conditions for each unit before starting the series operation. Initial tests might be carried on step by step as follows:

Step 1: Separate running of each unit including:

a. Determination of primary pretreatment chemical dosages by jar test and setting up of a pretreatment optimization database and a pretreatment optimization system (such as streaming potential technique).

b. With the best pretreatment, taking the thickening test: changing feeding and underflow rate to determine the optimizing underflow and overflow rate corresponding with different feeding rates by evaluating the clarity of the overflow, and the solid content of the underflow.

c. Under the steady operation of thickener, taking the dewatering test to determine the best operating conditions such as the maximum operating pressure for filter; feeding rate, pool depth, rotating rate, solids retention time for the decanter under different feeding concentration by evaluating the cycle filtrate or centrate rate, clarity of filtrate, cake solid content, cake peeling out characteristics for the filter, etc.

d. Determination of cycle rate, filtrate clarity, product purity under different operating conditions for the clarification and recovery stage.

Step 2: Series running of the whole process: Based on the operating data obtained from step 1, set up the optimum operating conditions for each downstream unit under conditions provided by the former unit. Running and evaluating the whole process operation.

Step 3: Process modification based on the testing results from step 2 and unpredicated factors during operations.

Step 4: Process design and scale up, cost analysis based upon the capacity requirement and information from step 1 to 3 and capacity requirement.

Detailed testing procedure for pretreatment, thickening and dewatering will be shown separately in the following sessions.

Session 2: Pretreatment Test

Contacting a fluid feed stream (typically a dispersion or slurry of solids, although not necessarily so) with a caustic water stream is performed. The caustic water may be obtained from a quench loop or a mill loop, or combination of both of a typical spent catalyst recovery operation. The main chemical contents of the feed slurry include spent catalyst (including hydrocarbons) fines, sulfur, metals (Mo2+, V+, Ni2+, Fe3+, A13+), toluene, and the like. N a preferred process, the objective is solids removal, metal ions removal, and hydrocarbon recovery. An accumulated particle size distribution of a sample from a commercial mill loop is shown in FIG. 2-1. About 100% of particles fall in the region smaller than 25 μm. With this large amount of fine particles, coagulation and flocculation pretreatment is required. The present invention contemplates the novel idea of using, in a pretreatment step, a combination of chemicals comprising a zeolite as an absorbent material to absorb materials which can not be captured by coagulation or flocculation, a settling aid to improve settling rate, and a filter aid to decrease filter cake compactability. All three are introduced (together or separately) in the pretreatment stage.

Pretreatment Chemicals and Dosages

The pretreatment chemicals also include a base chemical (preferably NaOH) to adjust pH, as well as a zeolite as an absorbent, a settling aid and a filter aid, a cationic polymer (for example the cationic polymer in emulsion form with high relative molecular weight known under the trade designation “Superfloc® SD-2061”, and referred to herein as C-5) and an anionic polymer (for example the anionic polymer in emulsion form with high relative molecular weight known under the trade designation “Superfloc® A-1883” referred to herein as A-a).

The optimum dosages of NaOH, zeolite, C-5 and A-a are determined from a “jar test”, preferably in a laboratory setting. The jar test procedure is presented in Session 6. Due to continuing variation of feed slurries from the process, the optimum chemical dosages will tend to vary corresponding to different feed slurries. Therefore, in accordance with the invention, a pretreatment database is prepared for the optimum dosages of chemicals corresponding to different feeds. Primary selected dosages of NaOH, zeolite, C-5 and A-a are determined from the jar test (testing results are shown in Session 6) and are such as listed as follows:

NaOH: until pH reaches 13

Zeolite: 0.7% weight

C-5: 3 ppm (original slurry should be diluted to 0.05% before being used)

A-a: 0.3 ppm (original slurry should be diluted to 0.005% before being used)

Pretreatment Procedure

1. Sampling of the feeding slurry, and testing the zeta potential, PSD, solid weight percent, pH, turbidity, and composition of the sample (Table 1-1). Running jar test, and determining the best dosage for the slurry. Filling the feeding slurry and the pretreatment information into the pretreatment database.

2. Feeding the tank with slurry, pump in the caustic water to adjust pH to an acceptable value. Adding zeolite at the dosage determined from 1, mixing for 5 minutes, and adding C-5 at the dosages determined by 1. Feeding the flocculated slurry to the tank before the thickener, and adding the A-a at the optimum dosage determined by 1. (Since there is enough detention time of slurry and chemicals in tank 1 of FIG. 1, 5 minutes' mixing of the zeolite might not be necessary)

3. Sampling the feeding slurry to the thickener, and testing the zeta potential, PSD, solid weight percent, pH, and compositions (Table 1-1). Preparing the pretreatment database.

4. Modifying the pretreatment design and the optimum dosages of NaOH, Zeolite, C-5 or A-a by zeta potential of the feeding slurry to the thickener, operation of the thickener, dewatering, and the final results from clarification and recovery stage.

5. Developing the pretreatment database for different feed slurries. Developing an automatic pretreatment optimization system (based on the database or streaming potential).

Session 3 Thickener Test

Introduction and Material Balance

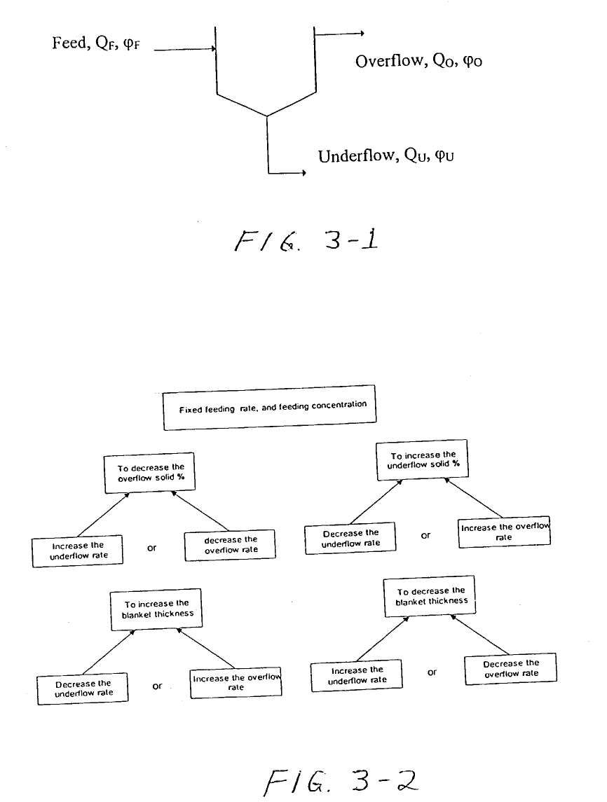

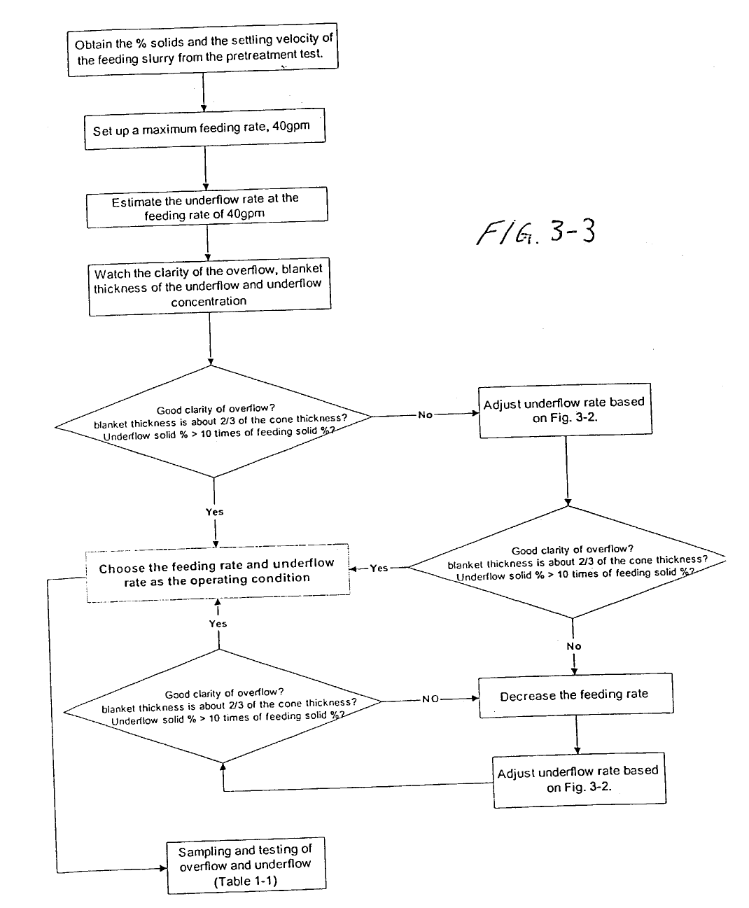

After pretreatment, flocculated and conditioned solid/liquid system enters the continuous thickener. A thickener is preferably used as the first step of solid/liquid separations, and can provide liquid removal rate of up to 90%. A schematic continuous thickener with three streams is shown in FIG. 3-1. Description and symbols for the three streams are shown in Table 3-1.

TABLE 3-1
Three Flows in Continuous Thickener

| Three Flows | Solid Concentration by wt, % | Flow rate, gpm |
|---|---|---|
| Feed | φ_{F} | Q_{F} |
| Overflow | φ_{O} | Q_{O} |
| Underflow | φ_{U} | Q_{U} |

Relationship of the three flows and solid concentration are given by material balance as follows. For steady flow,

Q_{F}=Q_{O}+Q_{U} (3-1)

Material balance on the solid basis for steady flow gives:

Q_{F}φ_{F}=Q_{O}φ_{O}+Q_{U}φ_{U} (3-2)

Testing Design

One useful continuous thickener for use in pilot scale tests is available is the thickener known under the trade designation “Delta-Stak” thickener # 20, from Eimco, Company. This thickener can be equipped with internal elements construction to increase the particle retention time in the thickener and to improve the separation efficiency. Sedimentation area of this model equals ˜25 ft². For the fixed equipment, the thickening operation is determined by feed rate, feed concentration, φ_{F}, and the settling velocity of particles in batch sedimentation tests. The optimum operating conditions is provided by the feed rate, underflow rate and overflow rate at which the best clarity of overflow, acceptable, steady blanket thickness, high underflow concentration, and the maximum overflow rate. Testing starts at a fixed maximum feeding rate. The corresponding underflow or overflow rate at this fixed feed rate are adjusted to produce acceptable solid concentrations in the overflow and underflow, acceptable blanket thickness, and acceptable underflow and overflow rate when the operation is running at steady state. Some instructions for underflow or overflow adjustment are illustrated in FIG. 3-2. If no matter how the underflow or overflow rate vary, there are no satisfying results under the fixed feed rate, another test should start at a lower feed rate.

In a typical pilot test, the feed solids concentration is 1-3 percent by weight. The maximum feed rate is 40 gpm. The batch sedimentation velocity from jar test is listed on “Jar Test Results” of Session 6, and is approximately 2.36 in/min. The overflow rate can be estimated by product of settling velocity and settling area equaling about 18 gpm. From Eq. (3-1), the approximate underflow rate=feeding rate−overflow rate=40 gpm−18 gpm=22 gpm. Therefore, the initial feeding and underflow rate can be set as 40 gpm and 22 gpm respectively.

Testing Procedure

One testing flow chart and procedure is illustrated in FIG. 3-3.

Session 4 Plate and Frame Filter Test Test Design

In a typical pilot test as illustrated by FIGS. 1-1 or 1-2, dewatering of the thickened slurry from underflow of the thickener will be tested by a batch plate frame filter or a continuous decanter. Testing and operation of the decanter will be presented in Session 5.

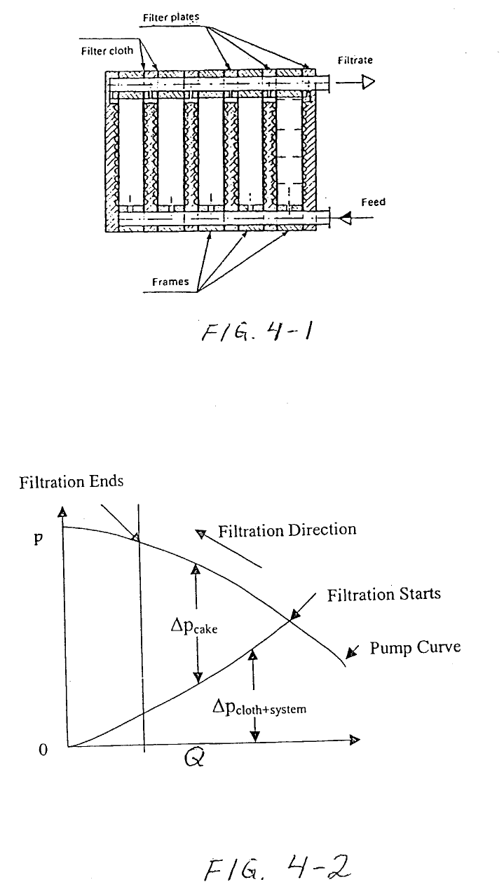

A typical plate and frame filter consists of plates, hollow frames and filter cloth as shown in FIG. 4-1. (Tiller, Li, “Theory and Practice of Solid/Liquid Separation”, 2001). The plates and frames with filter cloth in between are closed manually or hydraulically and form filter chambers. Generally, slurry is pumped into the chamber from the bottom; solids are rejected by the filter cloth and form cake inside the chamber; clear liquid goes through the cake and filter cloth under the pumping pressure and is collected as filtrate on the top. The total pumping pressure p equals the pressure drop across the cake and across the filter cloth and the system Δp_{cloth+system}:

p=Δp_{c}+Δp_{cloth+system} (4-1)

In a cake filtration, with cake building up, the total cake resistance is increasing; the pumping pressure is increasing; and the filtrate rate is decreasing as shown in FIG. 4-2. The point at which to stop the operation preferably provides the maximum cycle filtrate rate, high cake solid contents, and within the operating pressure range. If the filtration time is t_{F}, the dead time required for cake discharge and prepare for another cycle is t_{D}, the cycle rate is given by

$${q}_{cycle} = \frac{V}{( {t}_{F} + {t}_{D} ) A} \qquad \text{(4-2)}$$

in which A is the total filtration area.

Therefore, in the test, data needed to be collected in the test include 1) the volume of filtrate as a function of time, 2) the dead time for calculation of cycle rate at some possible ending points. Before and after one cycle, sampling and testing include the feeding solid concentration, the filtrate concentration, the cake concentration, and some other properties as shown in Table 1-1 are also required. In addition, the discharging properties of cake from the filter cloth after filtration is also required to be recorded. Some important parameters of the plate and frame filter are shown in Table 4-1.

TABLE 4-1
Plate and frame filter parameters

Type
Manufacturer
Size of Plates
Number of Plates
Total Filter Area, ft²
Filter cloth
Operating Pressure Range, psi

Testing Procedure

1. Before Start Filtration

a. Install the cloth on the filter plates and put the plates in the filter press frame then close the press and pressurize the hydraulic cylinder to the proper pressure.

b. Pump calibration;(pump instruction)

c. Close the press and make sure the closing hydraulic pressure was reached before tightening the locking ring. Close the bottom filtrate rate valves and open the top filtrate valves. Close the air blow inlet valves and wash water inlet valves.

d. Sample feeding slurry, and test the required properties in Table 1-1.

2. During Filtration

a. Pump in the thickened slurry or sludge from the surge tank between the thickener and filter.

b. After the press is filled, filtrate will come out from top of the press. Start timing and measuring the volume of filtrate against time. It is recommended to obtain p as a function of time. The time interval for testing should be short at the beginning of filtration, such as 30 sec., and extend to 1 min., 2 min. or 5 min. during the filtration when filtrate flow goes steady. If the volume is not available, measure the flow rate of filtrate as function of time, and use

$$V = {\int }_{0}^{t} Q ⅆ t$$

to calculate V at different time.

c. Check the cake concentration after 6 minutes of operation by opening the bottom valve of the plate.

d. Continue filtration until the flow rate decreases to 10-15 liter/(m².h) about 0.0037 to 0.0061 gpm/(ft²), and the pressure reaches some percentage of the designed maximum pressure.

3. Finish Filtration

a. Turn off the pumps and shut all pump suction valves to prevent siphoning through the pump. Open the slurry drain valve slowly to vent to pressure on the press. Wait until the pressure is 0 psi before open the press.

b. When the pressure reaches 0 psi, with the slurry drain valves open, open the press and drop the cake.

c. Watch the discharging of cake from the cloth, and classify the cake releasing properties by “drop”, “excellent”, “good”, “fair”, or “poor” defined as follows:

d. Watch the uniformity of the cake from cake surface to the medium, and get four type of cake sample: at cake surface, at the cake medium, in the middle, and mixing of the three. Measure the solid % of the four samples.

4. Clean, fix, and prepare for another cycle. Record the required total cleaning, fixing and preparing time.

5. Data Analysis and Results

a. Plot the total volume of filtrate against time.

b. Calculate the total cycle rate by (4-2) and plot against time or pressure to determine the ending filtration point corresponding to a maximum pressure and a low filtrate flow rate.

c. Obtain the average cake solid contents by sampling and testing. A good filtration will provide a high cake solid %.

d. Evaluate the clarity of filtrate.

e. Evaluate cake discharging.

f. Depending on b, and c, determine the best ending point. Depending on d, select the best filter cloth.

Table 4-2 provides a plate and frame filter test datasheet.

TABLE 4-2
Plate and frame filter test datasheet

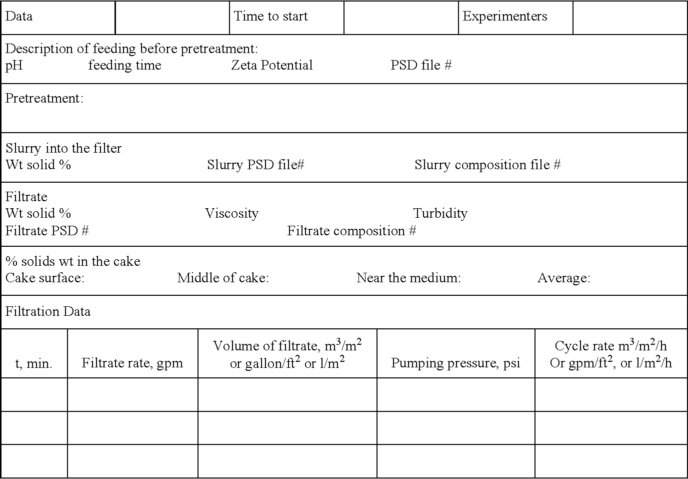

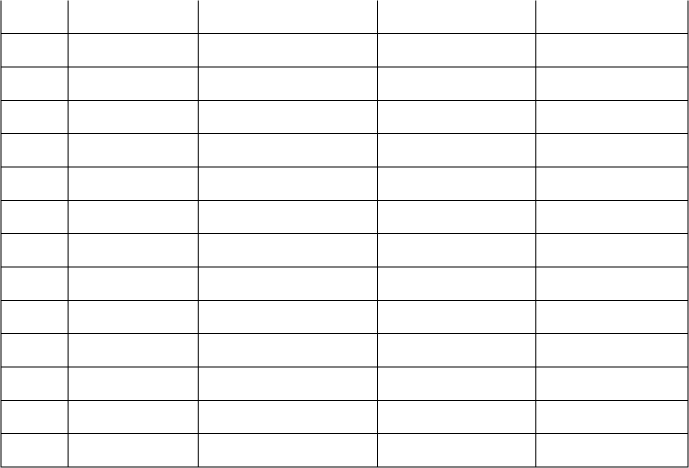

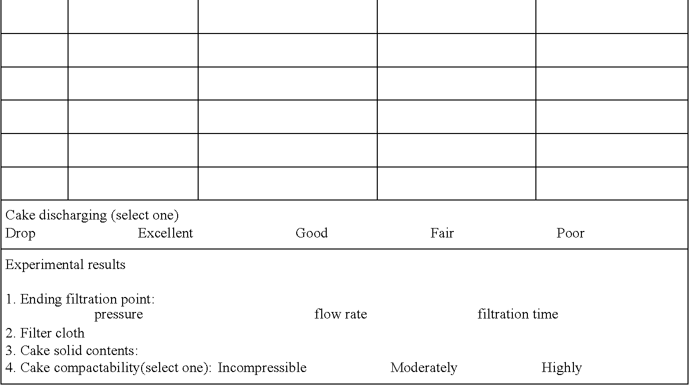

Session 5 Decanter Centrifuge Test

Introduction

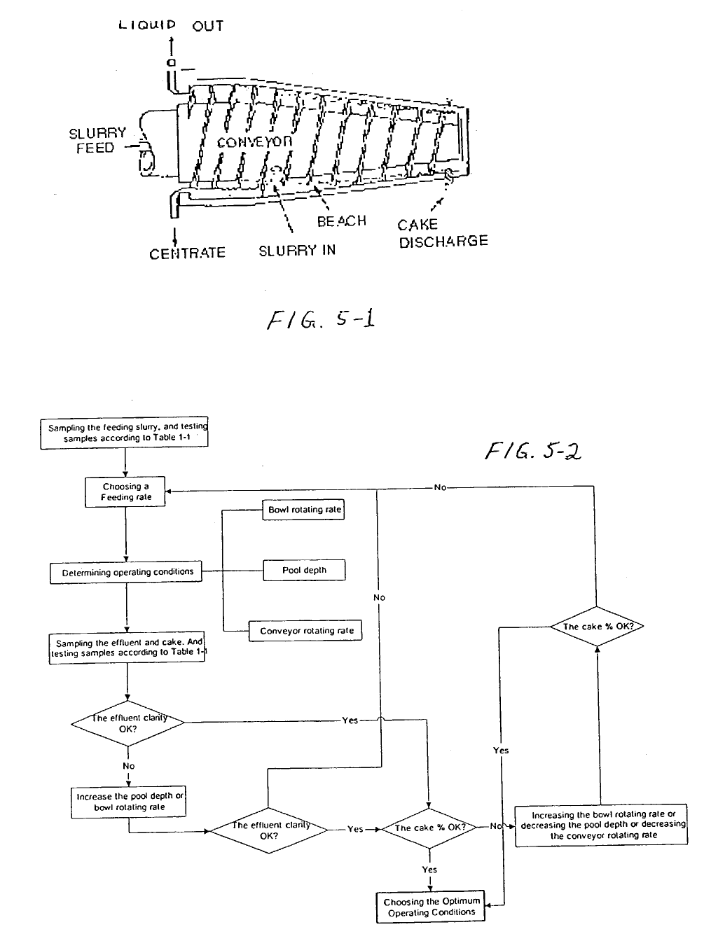

The sedimenting centrifuge or decanter centrifuge is a continuously operated unit option of the batch plate and frame filter for dewatering of thickened underflow slurry from the thickener. A typical decanter is illustrated schematically in FIG. 5-1 (Tiller, Li, “Theory and Practice of Solid/Liquid Separation”, 2001). It is consists of a solid bowl partially cylindrical and partially cone like, and a screw inside. Both the bowl and the screw are rotating but at different speeds. Solids settle on the bowl and are moved by the screw to the cone region that is called beach and are discharged. Liquid is discharged in another end as centrate from the weir. The height of the weir from the bowl is called the pool depth and can be adjusted. The operating conditions of a decanter centrifuge include: feed rate, bowl rotating rate, pool depth and the solids retention time. The performance of a decanter is also determined by the physical, and chemical nature of the feeding material, particle size distribution, particle density, surface properties, and the cake compactibility. The testing data to evaluate the performance of a decanter include the solid % of feed, cake and centrate, and the uniformity of discharged cake.

Test Design

As has been indicated, the performance of the decanter can be affected by the operating conditions such as feeding rate, the bowl rotating rate, the pool depth, and solids retention time determined by the screw or the conveyor rotating rate. The performance is evaluated by the efficiency, and capacity of the equipment. The objective of the test is to obtain data to evaluate the operation of the decanter so as to determine the optimum operating conditions as a basis for scale up and large-scale equipment operation.

In pilot tests, and in accordance with the invention, it is preferable to vary one operation condition and keep other conditions constant in one run. The minimum test program should include 2 bowl rotating speed, 2 pool depth, and 2 conveyor speeds where running at 3 different feed rates. There are totally 18 runs. A general test outline is as follows.

Determination of the Operating conditions Under Test:

1. Bowl rotating rate: Estimate the bowl rotating speed by spinning a sample in a laboratory centrifugal test. If the solids settle very fast, choose a bowl rotating rate around 50% to 70% of the maximum rate.

2. Pool depth: The higher the depth, the higher the clarity of the centrate, but in the sacrifice of decreasing of % solid in the cake. On the other hand, decreasing the pool depth will increase the solid contents, but decrease the liquid clarity. For low-density slurry, choose high pool depth that is about 90% of the maximum depth. In the case of a high solid density, a low pool depth is suggested.

3. Conveyor rotating rate: differential of the conveyor rotating rate and the bowl rotating rate indicates the solid discharging rate. The initial conveyor rotating rate can be determined by the cake formation rate in a lab centrifugal tube test.

Testing Procedure

Vary one condition and keep others constant in one run of tests. A testing logic flow chart is illustrated schematically in FIG. 5-2.

Data Sheet and Relating Calculations

A typical data sheet for test and relating calculations are shown in Table 5-1.

TABLE 5-1
Decanter Centrifuge Testing Data Sheet

| | | |
|---|---|---|
| Date | Experimenters | Material |

Testing Machine Model or #

| Run | 1 | 2 | 3 |
|---|---|---|---|
| Operating Conditions | | | |
| Temperature | Measured | | |
| Machine RPM | Measured | | |
| Pool Depth, Inches | Measured | | |
| Gear Ratio | Measured | | |
| Delta | Measured | | |
| Torque In LB | Reading | | |
| Motor Volts | Measured | | |
| Motor Amps | Measured | | |
| Motor KW | Measured | | |
| XG | RPM × (Diameter in Feet)/600 | | |
| Testing Results | | | |
| % Feed | Measured | | |
| % Cake | Measured | | |
| % Effluent | Measured | | |
| % Solids Recovery | $= \frac{\% Cake \times ( \% Feed - \% Effluent )}{\% Feed \times ( \% Cake - \% Effluent )}$ | | |
| Volume of Wet Cake, ft³ | Measured | | |
| Weight of Wet Cake, lbs. | Measured | | |
| Specific Gravity of Cake | = (Wt. of Wet Cake in lbs.)/ | | |
| | (Volume of Wet Cake in ft³)/62.4 | | |
| Density of Cake, lbs/ft | = (Specific Gravity of Cake) × | | |
| | 62.4 lbs/ft³ | | |
| Feed GPM | Measured | | |
| Dry Solids Rate in the feed, | = (Feed GPM) × (8.34 lb/gal.) × | | |
| Pounds/Hour(PPH) | (sp.grav.) × (%Feed/100) × | | |
| | 60 min./hour | | |
| Dry Solids Rate in the cake, | = (Feed GPM) × % Solids Recovery | | |
| (PPH) | | | |
| Cake Discharging Rate, PPH | = (Dry Solids Rate in the Cake)/ | | |
| | (% Cake) | | |
| Cake Discharging Rate, Ft³/Hr | = Cake Discharging Rate in | | |
| | PPH/(Specific Gravity of cake) | | |

Session 6 Jar Test

Jar Test Procedure

1. Introduction on Pretreatment

In solid/liquid separation (SLS), pretreatment of the solid/liquid slurry is usually necessary to increase the separation efficiency. There are two types of pretreatment: coagulation or flocculation and the addition of filter aids. The objective of coagulation is to increase the particle size that will improve the settling rate in sedimentation operation. The addition of filter aid is to increase the filtrate flow rate in filtration operation. The fundamental theory and experimental jar tests for coagulation and flocculation have been shown in Chapter 4 of the “Theory and Practice of Solid/Liquid Separation—the fourth edition” by F. M. Tiller, and W. P. Li, 2001.

In the SLS processes of the present invention, the pretreatment involves both coagulation and flocculation and the addition of filter aids to the body slurry. Two polymers, for example C-5 and A-a, and a rigid solid zeolite material (Z) are selected for primary pretreatment. In commercial plant operations made by the inventor, the characteristics of feed slurry to our SLS system is not consistent and can vary with pH. A database of the optimizing pH, dosages of C-5, A-a and Z for feed of different pH has been obtained by jar test. Due to the variation of slurry feed to the inventive SLS process, the database needs to be modified. A series of jar tests need to be taken for the database modification.

Objectives

The objective of pretreatment test is to obtain the best pH, dosages of Z, C-5 and A-a for each sample. The best pH, dosages of Z, C-5 and A-a are the combination which will provide the best clarity of supernatant, the largest water removal rate, the fastest settling rate in the sedimentation test, and the best filtering and dewatering characteristics in the filtration tests.

Jar Test Design

Each run of the jar test can compare 4 or 5 different treatments as shown in FIG. 4-6 (F. M. Tiller and W. P. Li, “Theory and Practice of Solid/Liquid Separation”, Chapter4, p4-8, 2001). The basis of design is changing one factor and keep the other factors constant. A preferred testing sequence is pH, then Z, then C-5, then A-a. Therefore two or three runs of jar test would be necessary to have the best dosages of Z, C-5 and A-a under a best pH.

Test Procedure

1. Sampling

Samples are not consistent, and are aging with time. It is preferred that the samples are fresh and representative. Data needed about the sample include: sampling time during the process, pH, turbidity, zeta potential, and solids concentration.

Sampling Procedure:

1) Mix the slurry in the sample tank;

2) Take four 300 ml samples while mixing and pour into four 500 ml beakers respectively.

3) Take samples while mixing for concentration, pH, turbidity and Zeta potential test.

4) Test pH, turbidity and Zeta Potential

5) Take 2-3 ml of sample, weigh, and put into an oven or drier. Weigh the dry solids. Concentration in mass basis=dry weight/wet weight. Concentration in volume basis φ_{S}=(dry weight(kg)/density of solids(kg/m³))/[(wet weight−dry weight)(kg)/1000+(dry weight(kg)/density of solids)]. The density of solids is assumed as 1700 kg/m³.

2. Adjusting pH

pH is an important factor in pretreatment. The best pH will increase the Zeta Potential to 5 mv to 3 mV. 25% NaOH, and 25% of H₂SO₄ are used to adjust pH.

3. Adding Zeolite

Mix the slurry at 100 rpm, add Zeolite based on primary pretreatment database(Table 6-1), and keep mixing for 2 minutes. The primary amount of Z is 2.2 g per 300 ml slurry. This amount needs to be modified.

4. Adding an Cationic Polymer

Decrease the mixing rate to 60 rpm, add polymer (primary 3 ppm). Keep mixing at 60 rpm for 1 minute.

5. Adding an Anionic Polymer

At 60 rpm, add polymer(primary 0.3 ppm). Keep mixing at 60 rpm for 1 minute, and reduce the mixing rate to 30 rpm, and mix for 10 minutes. Record the time at which flocs will be formed. Prepare for the sedimentation test before stop the mixer.

6. Sedimentation Test

Stop mixing (from step 5). Record the time at which the interface of supernatant and the slurry settles to 5 cm, 4 cm, 3 cm, and 2 cm for each beaker. After 5 minutes, record the thickness of the sediment L and the height of total liquid in the beaker Ho after 10 minutes of settling. The liquid recovery can be estimated as

$$\frac{1 - L / Ho}{1 - {ϕ}_{s}} .$$

Take 25-28 ml of supernatant in the sample tubes for turbidity test and chemical analysis.

7. Funnel Gravity Filtration test

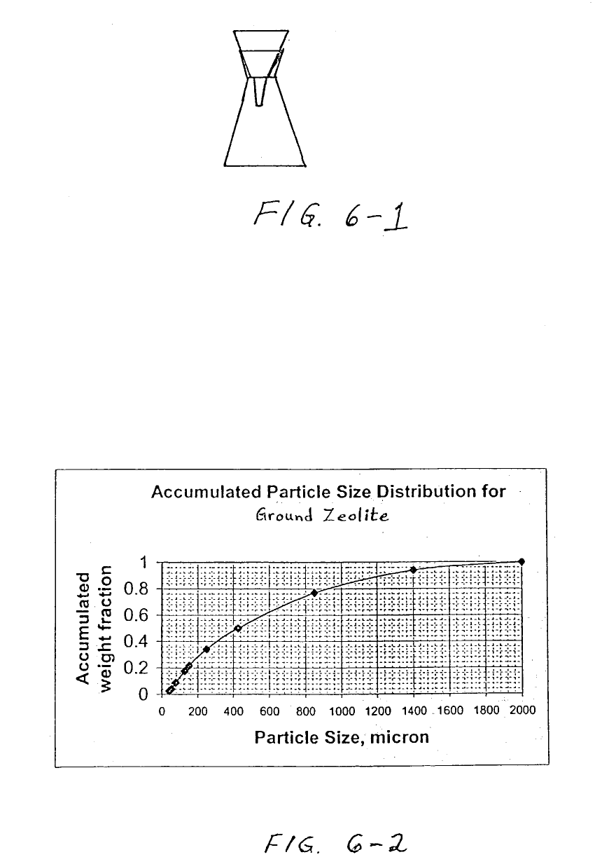

Pour out the liquid, and pour the sediment into the funnel with Quality 1 filter paper. (FIG. 6-1). Record the drops of filtrate and the corresponding time, and calculate the filtrate rate=volume of filtrate/time.

8. Data Analysis

Compare the turbidity of supernatant, settling rate, thickness of the sediment and the liquid removal rate in the sedimentation test; and the filtrate rate in the funnel gravity filtration test. The best pretreatment is the one with the lowest supernatant turbidity, largest settling rate, the smallest sediment thickness, the largest liquid removal rate, and the best filtrate rate. Analyze testing results, and give the best pH, dosage of Z, C-5 and A-a.

Data sheet for Table 6-2 gives jar test.

Jar Test Results

Pretreatment Chemicals

Pretreatment chemicals include NaOH to adjust pH for primary coagulation, zeolite as an absorbent, settling aids and filter aids, an cationic polymer C-5 and an anionic polymer A-a. Descriptions of Zeolite, C-5, A-a is as follows:

NaOH: 50% to adjust pH for initial particle coagulation.

Zeolite

Type: ZS500 RW from GSA Resources Inc., Tucson, Ariz.

Description: natural mineral chabazite. Qualified for cation exchange and adsorption of radioactive waste and heavy metals.

Special treatment in our case: grinding

Particle Size distribution after grinding: illustrated in FIG. 6-2.

Other zeolites listed on GSZ Resources Inc. web site as compatible with this zeolite may be substituted, assuming proper PSD

Polymers:

There are two types of polymers used for flocculation, cationic C-5 and anionic A-a manufactured by CYTEC Industries Inc.

Properties:

C-5: “Superfloc® SD-2061, cationic polymer in emulsion form with high relative molecular weight.

A-a: “SUPERFLOC® A-1883, anionic polymer in emulsion form with high relative molecular weight.

Although the above description of preferred processes and apparatus of the invention are representative of the invention, they are by no means intended to limit the appended claims.

What is claimed is:

1. A solid/liquid separation process for treating a fluid stream comprising solid particles, wherein about 80 percent of the solid particles have a particle size of 25 micrometers or less, the process employing a pretreatment stage, a thickening stage, a dewatering stage, and a clarification stage, the process comprising:
(a) performing a first separate running of each of a pretreatment stage, a thickening stage, a dewatering stage, and a clarification and recovery stage, including:
i. (i) determining primary pretreatment chemical dosages of a pH additive, a modified zeolite, an anionic polymer, and a cationic polymer, and by jar test and setting up of a pretreatment optimization database including parameters selected from the group consisting of zeta potential, particle size distribution, solids weight percent, pH, turbidity, composition, and combinations thereof, of the fluid stream, and a pretreatment optimization system;
ii. with the best pretreatment identified, performing a thickening stage test by changing feed rate to and underflow rate from a thickening stage to determine best underflow rate and overflow rate corresponding to different feeding rates by evaluating the clarity of the overflow, and the solid content of the underflow;
iii. under steady operation of the thickening stage, performing a dewatering stage test to determine best operating conditions selected from the group consisting of the maximum operating pressure for a filter, decanter feeding rate, pool depth, rotating rate, solids retention time under different dewatering stage feed concentrations by evaluating cycle filtrate or centrate rate, clarity of filtrate, cake solid content, and cake peeling out characteristics for the filter;
iv. determining cycle rate, filtrate clarity, and solids product purity under different operating conditions for the clarification and recovery stage;
(b) series running of steps (a)(i)-(iv) simultaneously based on operating data obtained from the first separate running of each stage separately, setting up best operating conditions for each stage under conditions provided by the preceding stage; and
(c) modifying the overall process based on testing results from step (b) and unpredicted factors during operations.

2. The process of claim 1 wherein 100 percent of the solid particles have a particle size of 25 micrometers or less.

3. The process of claim 1 wherein 90 percent of the solid particles have a particle size of 4 micrometers or less.

4. The process of claim 1 wherein the setting up of the pretreatment optimization system uses a streaming potential technique.

5. The process of claim 1 further comprising performing a process design and scale up and a cost analysis based upon the capacity requirement and information from steps (a), (b), and (c).

6. An apparatus for solid/liquid separations, the apparatus comprising:
(a) a pretreatment means adapted to absorb, coagulate and flocculate solid particles within a fluid stream;
(b) the pretreatment means fluidly connected to a means for thickening;
(c) the means for thickening fluidly connected to means for dewatering selected from the group consisting of a plate and frame filter, a decanter centrifuge, and combinations thereof, and
(d) the means for thickening also fluidly connected to a means for purification and recovery comprising at least one of a guard filter, a coalescer, and a carbon bed.
